(19) United States
(12) Patent Application Publication
(10) Pub. No.: US 2006/0109388 A1
(43) Pub. Date: May 25, 2006

(54) Wireless signal system for a video display unit

(75) Inventors: Todd Sanders, Zeeland, MI (US); Sam Galioto, Holland, MI (US); Larry E. Mathias, Byron Center, MI (US); Paul D. Hurley, Holland, MI (US); L. Matthew Leeka, Holland, MI (US)

Correspondence Address: FOLEY & LARDNER LLP, 777 EAST WISCONSIN AVENUE, SUITE 3800, MILWAUKEE, WI, 53202-5308, US

(73) Assignee: Johnson Controls Technology Company

(21) Appl. No.: 11/188,116

(22) Filed: Jul. 22, 2005

Related U.S. Application Data
(63) Continuation-in-part of application No. 09/868,536, filed on Jan. 8, 2002.
(60) Provisional application No. 60/113,876, filed on Dec. 28, 1998.

(51) Int. Cl. H04N 5/64

(52) U.S. Cl. 348/837; 248/919

(57) ABSTRACT

A video display system for a vehicle may comprise a housing coupled to a vehicle interior element and a video screen assembly coupled to the housing and moveable between a stowed position and a non-stowed position. The assembly may comprise a display screen and a wireless transmitter configured to transmit a first wireless signal.

### CROSS-REFERENCE TO RELATED APPLICATIONS

This Application is a continuation-in-part of co-pending U.S. application Ser. No. 09/868,536, filed Jan. 8, 2002, which is the National Stage of International Application No. PCT/US1999/030993, filed on Dec. 28, 1999, which claims the benefit of U.S. Application Ser. No. 60/113,876, filed on Dec. 28, 1998.

This Application claims the benefit of priority as available under 35 U.S.C. §§ 119-121 and 365 to the following Patent Applications (which are hereby incorporated by reference in the present Application): (1) U.S. application Ser. No. 09/868,536, filed on Jan. 8, 2002; (2) International Application No. PCT/US1999/030993, filed on Dec. 28, 1999; (3) U.S. Application Ser. No. 60/113,876, filed Dec. 28, 1998.

### FIELD

The present invention relates generally to a video display system, and, more particularly, to a video display system which is mountable in a vehicle and also removable for use outside the vehicle.

### BACKGROUND

Televisions and video cassette players have recently become quite popular in motor vehicles as a means of providing entertainment for both children and adults. Such devices, for the most part, however, have been limited to use in larger vehicles such as sport utility vehicles, mini-vans, and full size vans due to the space requirements for conventional televisions and video cassette players. Such systems have often been mounted in a console on the floor of a vehicle, as well as to the headliner of a vehicle. In either mounting, such systems require a significant amount of space. Also, such systems have typically not been removable easily from the vehicle for use outside the vehicle with an AC power source.

More recently advances in Liquid Crystal Display (LCD) panels have significantly improved the picture and contrast afforded by these types of displays, making them suitable for use in a wide variety of applications. LCDs are much thinner than conventional cathode ray tubes (CRTs) and therefore require significantly less space than a conventional television employing a CRT as a picture tube. LCDs are also much lighter in weight than CRTs, therefore making them readily portable, as evidenced by the popularity of laptop computers. The lightweight and compact configuration of an LCD panel would therefore enable it to easily be mounted in various interior areas of a motor vehicle such as a sport utility vehicle, truck, van, or car, where the mounting of a video screen having a CRT would not be possible because of space constraints.

Even more recently, Digital Video Disc (DVD) players have become increasingly popular. DVD players are significantly more compact than video cassette players, lighter in weight, generate less heat and offer significantly enhanced picture and sound quality over a VHS format videocassette. The extremely compact dimension of a DVD, which is essentially the same as a compact disc, further enables the dimensions of the DVD player to be kept very compact. DVD players are not limited to playing video discs, but can also play compact discs as well.

In view of the foregoing performance and compact size advantages offered by LCD panels and DVD players, it would be highly desirable to incorporate both such devices into an integrated LCD/DVD unit which could be easily mounted within a motor vehicle such as a car, sport utility vehicle, van, mini-van, or truck. More preferably, it would be highly desirable to incorporate an integrated LCD/DVD unit into a console in such a manner that the LCD/DVD unit can be quickly and easily moved into a viewable position, such as flipped down from a headliner mounted console, and also easily moved into a stowed position so that it is out of the way when not in use.

It would further be highly desirable to provide an LCD/DVD player which can be quickly and easily removed from its associated console so that the entire unit can be used outside of the vehicle with an alternate AC or DC power source.

### SUMMARY

One exemplary embodiment relates to a video display system for a vehicle comprising a housing coupled to a vehicle interior element and a video screen assembly coupled to the housing and moveable between a stowed position and a non-stowed position. The assembly comprises a display screen and a wireless transmitter configured to transmit a first wireless signal.

Another exemplary embodiment relates to a video display system for a vehicle comprising a video source for providing a video signal and a video screen assembly comprising a circuit board and a video screen, the video screen assembly being configured to display the video signal. The circuit board comprises a video driver and a transmitter for transmitting a first wireless signal and the video screen assembly is configured to be moveable between a stowed position and a non-stowed position.

Another exemplary embodiment relates to a video screen module for a vehicle comprising a video screen assembly comprising a circuit board, the video screen assembly being configured to display a video signal. The circuit board comprises a video driver, a transmitter for transmitting a first wireless signal, and a receiver for receiving a second wireless signal. The video screen assembly is configured to be moveable between a stowed position and a non-stowed position.

### BRIEF DESCRIPTION OF THE DRAWINGS

FIG. 1 is a front perspective view according to an exemplary embodiment;

FIG. 2 is a rear perspective view of the embodiment shown in FIG. 1 according to an exemplary embodiment;

FIG. 3 is an exploded view of the preferred embodiment shown in FIG. 1 according to an exemplary embodiment;

FIG. 4 is a front perspective view of an alternative preferred embodiment according to an exemplary embodiment;

FIG. 5 is an exploded view of the embodiment shown in FIG. 4 according to an exemplary embodiment;

FIGS. 6a and 6b are alternative embodiments of the housing of the embodiment shown in FIG. 4 according to an exemplary embodiment;

FIGS. 7a-7c are side views of the latch mechanism of the embodiment shown in FIG. 4 according to an exemplary embodiment;

FIG. 8a is a front view of a stand operable with the embodiment shown in FIG. 4 according to an exemplary embodiment;

FIG. 8b is a side view of the stand shown in FIG. 8a according to an exemplary embodiment;

FIG. 9 is a front perspective view of a tuner stand operable with the embodiment shown in FIG. 4 according to an exemplary embodiment;

FIG. 10 is a perspective view of an alternative embodiment of the present invention shown in FIG. 4 according to an exemplary embodiment;

FIG. 11 is an elevation view of the embodiment shown in FIG. 10 according to an exemplary embodiment;

FIG. 12 is a front perspective view of the housing of the embodiment shown in FIG. 10 according to an exemplary embodiment;

FIG. 13 is a bottom view of the embodiment shown in FIG. 10 according to an exemplary embodiment;

FIG. 14 is a perspective view of the embodiment shown in FIG. 10 according to an exemplary embodiment;

FIG. 15 is a perspective view of the embodiment shown in FIG. 10 according to an exemplary embodiment;

FIG. 16 is a front perspective view of an alternative embodiment;

FIG. 17 is an exploded view of the embodiment shown in FIG. 4 according to an exemplary embodiment;

FIG. 18 is a schematic illustration of a video screen console according to an exemplary embodiment;

FIG. 19 is a schematic illustration of a transmitter/receiver module according to an exemplary embodiment;

FIG. 20 is a partial side view of a video display system according to an exemplary embodiment;

FIG. 21A is a partial side view of a video display system according to an exemplary embodiment;

FIG. 21B is a detailed partial side view of a portion of the video display system of FIG. 21A according to an exemplary embodiment;

FIG. 22 is a partial side view of a video display system according to an exemplary embodiment; and

FIG. 23 is a partial side view of a video display system according to an exemplary embodiment.

### DETAILED DESCRIPTION OF EXEMPLARY EMBODIMENTS

The following description of the preferred embodiments is merely exemplary in nature, and are in no way intended to limit the invention or its application or uses. Moreover, while the detailed description discloses a specific vehicle interior trim component embodiment, one skilled in the art will recognize that any vehicle interior trim component could incorporate the present invention.

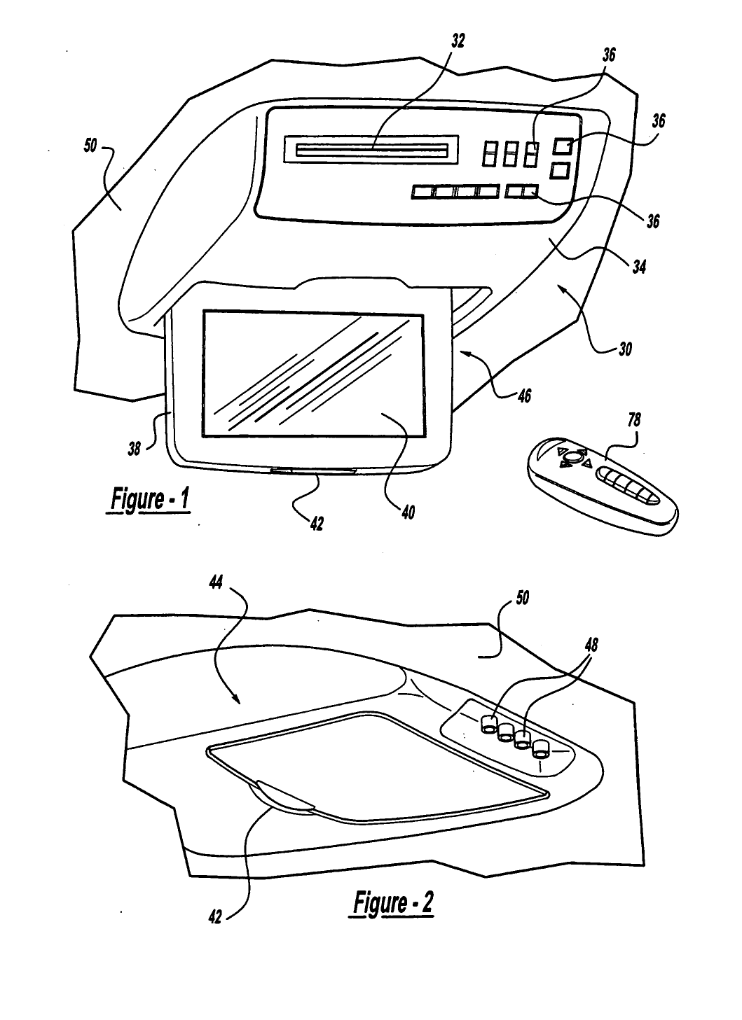

Referring to FIGS. 1 and 2, a video display system 30 is shown. The video display system 30 includes a digital video disc (DVD) player 32 that is integrated in a housing 34. The housing 34 also includes a plurality of controls 36 that allow a user to operate the DVD player 32. A screen console 38 having a screen portion 40 is rotatably mounted to the housing 34. Releasing a latch mechanism 42 allows the screen console 38 to rotate from a first or closed position 44 to a second or open position 46. The latch mechanism 42 is positioned substantially on the screen console 38 engageable with a portion of the housing 34. Alternatively, the latch mechanism 42 can be positioned substantially on the housing 34 engageable with a portion of the screen console 38. A plurality of audio connectors 48 are also integrated with the housing extending from the housing such that a user could connect speakers, headphones, or other conventionally known listening devices to the video display system 30.

Although the video display system 30 is depicted in FIGS. 1 and 2 as being mounted to a headliner of a motor vehicle interior, it will be appreciated by one of ordinary skill in the art that the video display system 30 could be mounted in several areas of a vehicle, including, but not limited to, a seat back, a floor console, a center armrest console, etc. Additionally, the video display system 30 is not limited to automotive applications. The video display system could easily be incorporated into similar components within the cabin of a boat, aircraft, etc.

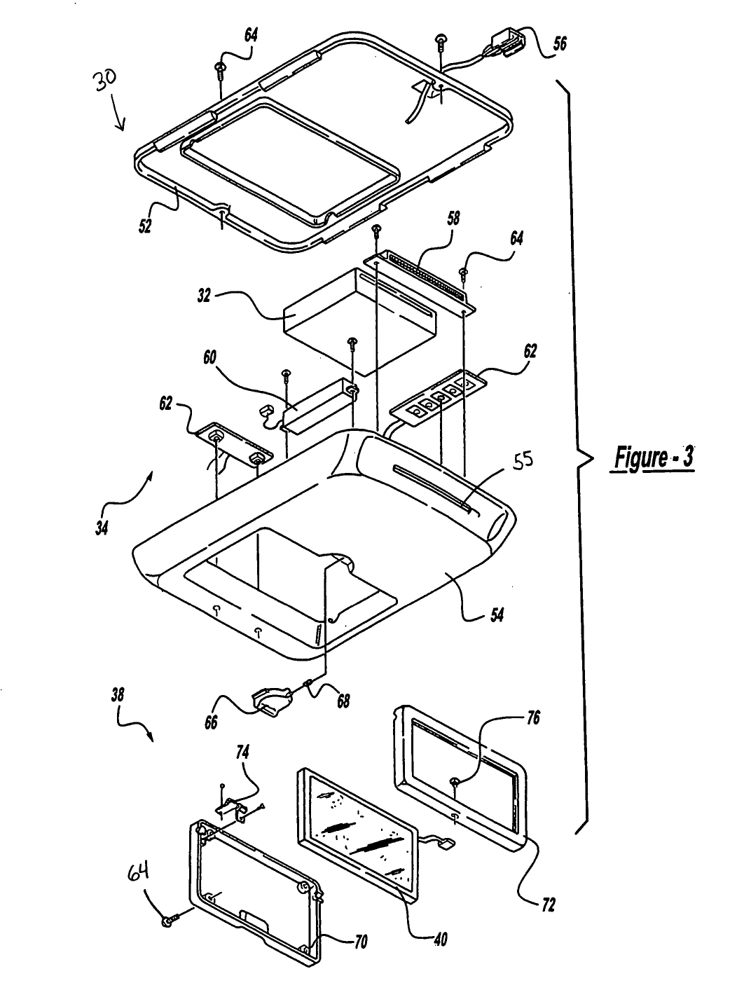

Referring to FIG. 3, the components of the video display system 30 are shown. The housing 34 includes a retainer portion 52 and a bezel portion 54, with a vehicle interface wiring harness 56 extending through the retainer portion 52 and the bezel portion 54 including a plurality of apertures 55. The plurality of apertures 55 are positioned accordingly on the bezel portion 54 in order to accommodate digital video discs and the plurality of controls 36. Several components are integrated in the bezel portion 54 and the retainer portion 52 of the housing 34. These components include the DVD player 32, a disc wiper assembly 58, and a power supply 60. Additionally, printed circuit boards 62 are integrated into the housing 34 providing, among other things, a user input and output interface with the audio connectors 48 and the plurality of controls 36 (shown schematically in FIGS. 1 and 2). Each of the components are fixedly secured within the housing. In a preferred embodiment, threaded fasteners 64 are used for this purpose. However, one of ordinary skill in the art will appreciate that other types of fasteners could be used with equal results and, therefore, are within the scope of this disclosure. Additionally, each component is operatively associated with the other components in any known conventional manner such that the DVD player functions as it is intended and, therefore, is also within the scope of one of ordinary skill in the art.

In FIG. 3, the first latch mechanism 42 includes a latch portion 66 and a latch spring 68 operatively associated with the bezel portion 54 of the housing 34 in order to retain the screen console 38 in a first or closed position 44. Alternatively, the first latch mechanism 42 could be positioned within the screen console 38 and operatively associated with the housing 34 in order to releasably retain the screen console 38 within the housing 34.

The screen console 38 includes a screen 40 (e.g., a display screen), preferably a liquid crystal display, positioned within a rear cover 70 of the screen console and a front cover 72 of the screen console 38. The screen console 38 is moveably associated with the housing 34. In a preferred embodiment, the screen console 38 is rotatably or pivotally associated with the housing 34 through the use of a torque hinge 74. The torque hinge 74 provides a smooth, constant, and controlled rotation of the screen console 38 from the first or closed position 44 to the second or open position 46 after the latch mechanism 42 is actuated by a user. One of ordinary skill in the art will appreciate that various types of hinge mechanisms can be used with equal results. Additionally, one of ordinary skill in the art will appreciate that the screen console 38 and screen 40 could be movably associated with the housing 34 such that the screen console moved from the first or closed position 44 to the second or open position 46 along an axial path after the latch mechanism 42 had been actuated. This type of movement would include, but is not limited to sliding in an upwardly or downwardly facing direction.

The screen 40 is also operatively associated with the components integrated in the housing 34 such that the DVD player 32 functions as intended in any conventionally known manner. Connecting the screen 40 in this manner is also within the skill of one of ordinary skill in the art. Additionally, conventionally known fasteners 64 are used to attach the torque hinge 74 to the housing 34 and the screen console 38. Conventionally known fasteners 64 are also used to attach the front cover 72 to the rear cover 70 thereby retaining the screen 40 within the screen console 38.

Also positioned on the screen console 38 is an infrared transmitter/receiver 76. Alternatively, the infrared transmitter/receiver 76 could be positioned on the housing 34 with equal results. The infrared transmitter/receiver 76 is operable to receive control signals from a remote control device 78 actuated by the user and operable to send audio signals to remote locations including, but not limited to, infrared headphones and speakers.

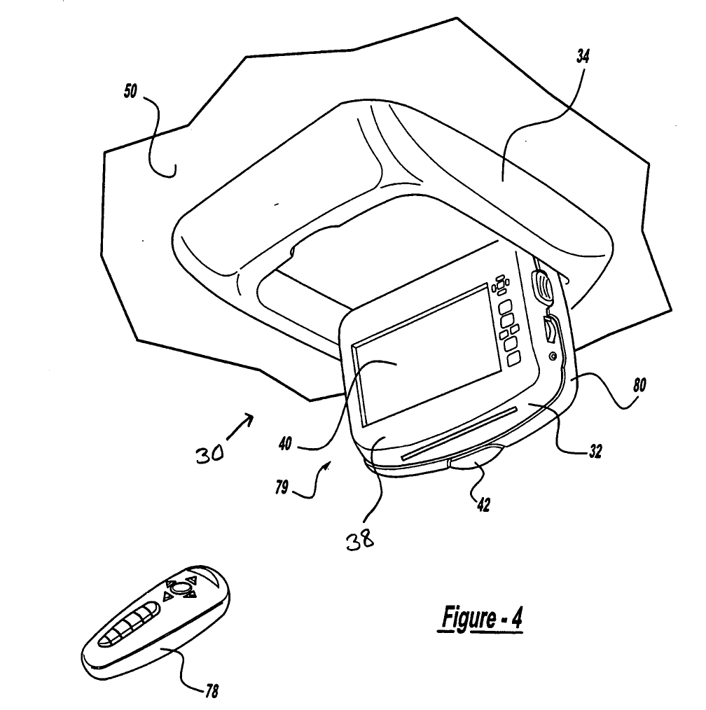

In an alternative preferred embodiment as shown in FIG. 4, the video display system 30 components can be operably arranged and integrated into the screen console 38 forming a self-contained video player unit 79 that is detachable from the housing 34. This alternative preferred embodiment will now be described in greater detail with features corresponding to the features of the above-described embodiment being referenced using the same reference numbers and reference signs.

Referring to FIG. 4, the video display system 30 of an alternative preferred embodiment is shown. The video display system 30 includes a DVD player 32 and a screen 40 integrated in a screen console 38 forming a video player unit 79 releasably attached to a housing panel 80. The housing panel 80 is moveably attached to the housing 34 and is operable to move between a first or closed position 44 and a second or open position 46, as previously described with reference to FIGS. 1-3. The housing panel 80 also incorporates a first latch mechanism 42 that releasably retains the screen console 38 and the housing panel 80 in the first or closed position 44 and, when actuated by a user, allows the screen console 38 and the housing panel 80 to be released and moved to the second or open position 46. In this embodiment, the screen 40 is a liquid crystal display.

Referring to FIG. 5, the screen console 38 is shown detached from the housing panel 80. The screen console 38 includes a second latch mechanism 82 operatively associated with the panel housing 80 to releasably connect the screen console 38 to the housing panel 80. In this embodiment, the screen console 38 also includes an infrared transmitter/receiver 76 operable to receive control signals from a remote control device 78 and operable to send audio signals to remote locations including, but not limited to, infrared headphones and speakers. Additionally, the screen console includes a plurality of controls 36 that allow the user to operate the DVD player and a slot 81 allowing insertion and removal of the digital video disc. The screen console 38 also incorporates an audio connector 86 and a corresponding audio control switch 88. One of ordinary skill in the art will appreciate that the audio connector 86 is operable to receive a connector from headphones or speakers.

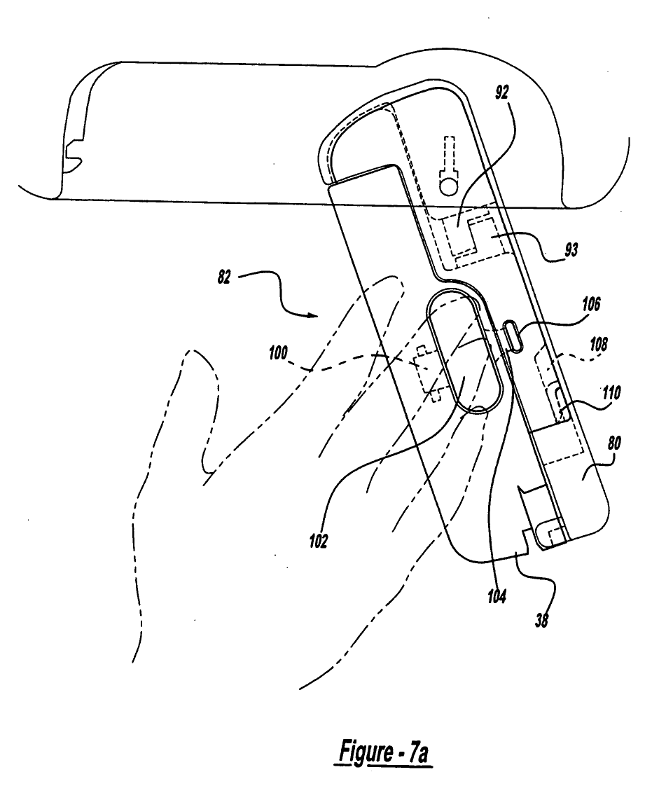

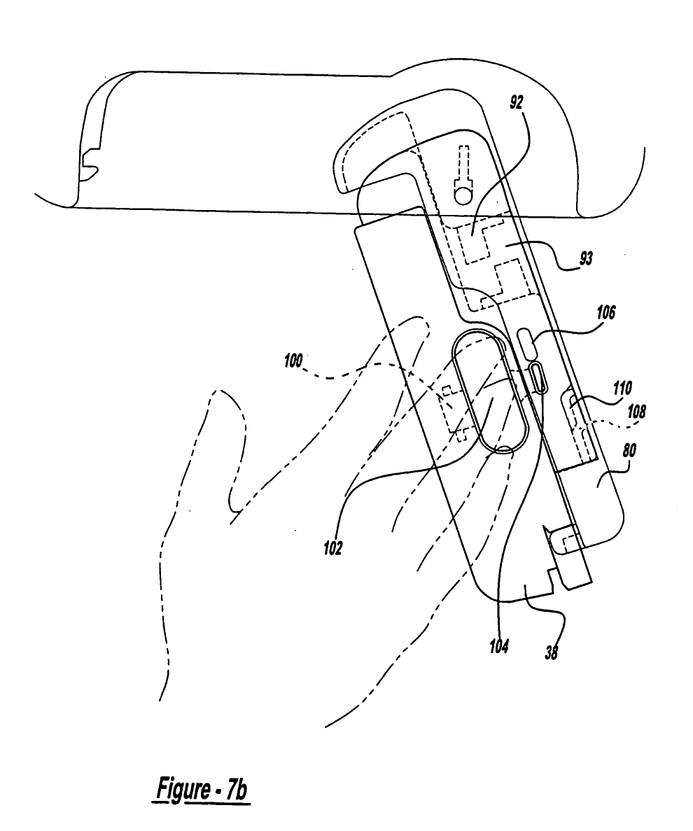

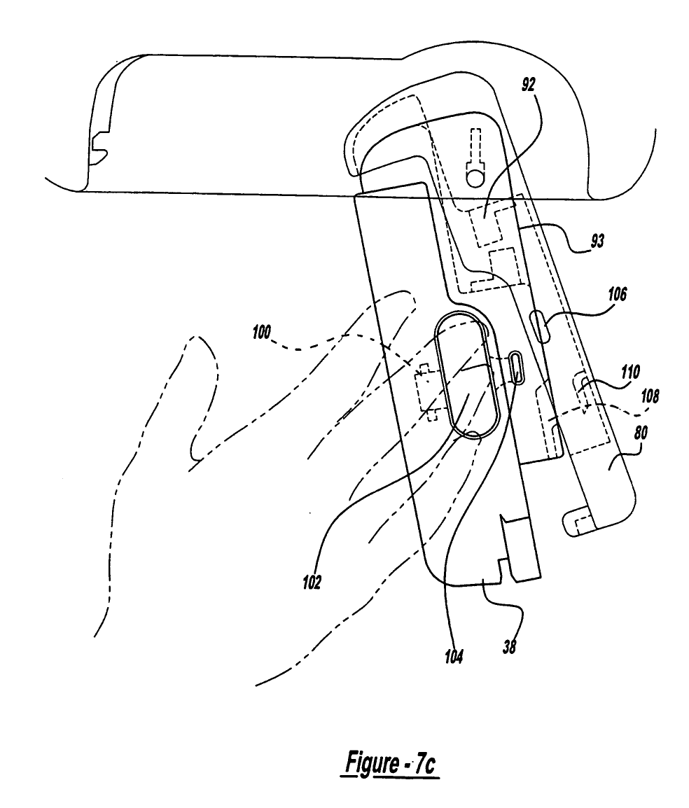

The screen console 38 in this embodiment also includes an auxiliary power connector 90. Again, one of ordinary skill in the art will appreciate that this connector is operable to receive power from various types of remote sources including, but not limited to an alternating current power source (e.g. a conventionally known power outlet in a home), and a direct current power source (e.g. a automobile battery, a conventionally known battery, etc.). Additionally, a rechargeable battery can be integrated in the screen console 38 providing power to the video player unit 79 when the video player unit 79 is detached from the housing panel 80 and being used in a portable capacity. The rechargeable battery recharges using the vehicle's electric power supply when the video display unit 79 is attached to the housing panel 80. As can be seen in FIG. 5, the housing panel 80 also includes a wiring harness connector 92 operable to engage a corresponding wire harness connector 93, as shown in FIGS. 7a-7c, positioned on a rear side of the screen console 38.

Although this embodiment is shown mounted to a headliner 50 of an automobile, it is within the scope of this disclosure that this video display system 30 could also be mounted to other interior components located within the automobile, including, but not limited to, seat backs, center consoles, etc.

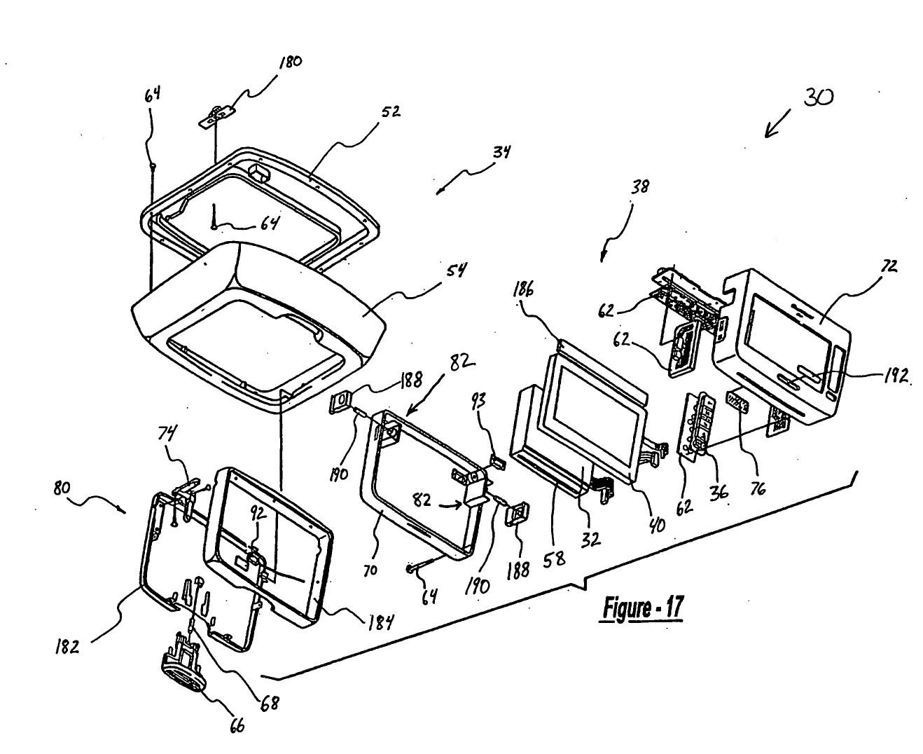

Referring to FIG. 17, the components of the video display system 30 of the alternative preferred embodiment shown in FIGS. 4 and 5 are shown. The housing 34 includes a retainer portion 52 attached to a bezel portion 54 using threaded fasteners 64. The housing 34 is attached to an interior trim component of a vehicle using at least one attachment clip 180. Although threaded fasteners 64 are used in this embodiment, it is specifically contemplated and, therefore, within the scope of this disclosure, that the retainer portion 52 and the bezel portion 54 can be attached together through any conventionally known means including, but not limited to, other types of fasteners and attachment brackets molded into the retainer portion and/or the bezel portion 54.

The housing panel 80 includes a display carrier portion 182 and a display carrier trim portion 184 fastened to each other using the means previously described. The housing panel 80 is moveably associated with the housing 34. In this preferred embodiment, the housing panel 80 is rotatably or pivotally attached to the housing 34 through the use of a torque hinge 74. The torque hinge 74 provides a smooth, constant, and controlled rotation of the housing panel 80 from the first or closed position 44 to the second or open position 46 after the latch mechanism 42 is actuated by a user. One of ordinary skill in the art will appreciate that various types of hinge mechanisms can be used with equal results. In this embodiment, the first latch mechanism 42 including a latch portion 66 and a spring latch 68 is positioned substantially on the housing panel 80 and operatively associated with the bezel portion 54 of the housing 34 in order to retain the screen console 38 in a first or closed position 34.

The screen console 38 includes a screen 40 and a DVD player 32 positioned substantially within a front cover 72 and a rear cover 70. The DVD player 32 and the screen 40 are positioned parallel to one another, and as both are integrated into the single unit screen console 38, pivot or rotate through the same arc or motion as the housing panel 80 moves from the first or closed position 44 to the second or open position 46.

Additional components are also positioned substantially within the rear cover 70 and the front cover 72 of the screen console 38. All of the components in this embodiment are operatively associated with each other in order to allow the DVD player to function as intended. These components include a plurality of printed circuit boards 62 providing input and output interfaces with a plurality of controls 36, and the audio connectors 86, power connectors 92, etc. shown in FIG. 5. A disc wiper assembly 58 and a screen inverter 186 are also provided within the screen console 38. In this embodiment, the infrared transmitter/receiver 76 and the infrared lens 192 are positioned on the front cover 72 while the second latch mechanism 82 and the wiring harness connector 93 are positioned on the rear cover 70. The second latch mechanism 82 includes a latch portion 188 and a spring portion 190. The wiring harness connector 93 corresponds to a wiring harness connector 92 positioned substantially within the housing panel 80.

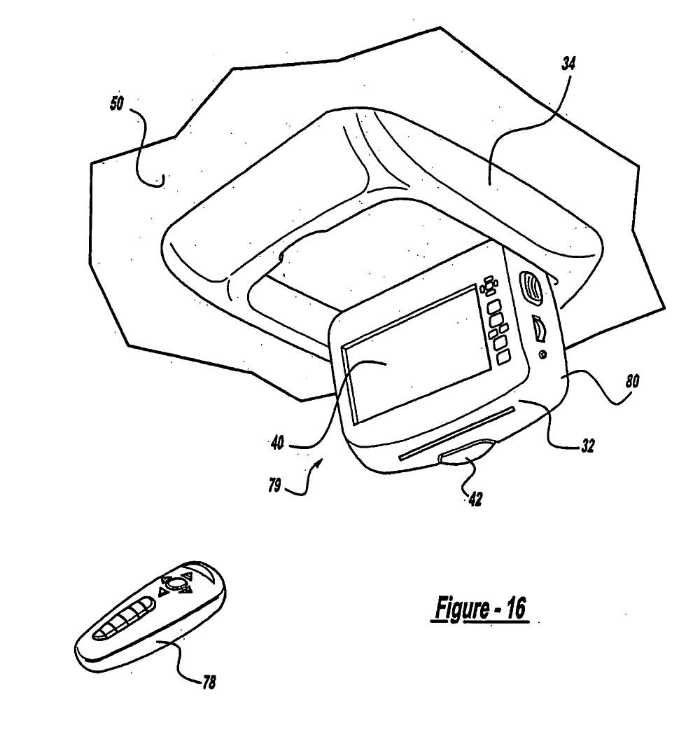

The alternative embodiment described in FIGS. 4, 5, and 17 may also be provided in a manner such that the screen console 38 is not removable from the housing panel 80, as shown in FIG. 16. In this embodiment, the positioning of the components of the video display system 30 is substantially similar to the positioning of the components shown in FIG. 17, the only difference being that the housing panel 80 and the screen console 38 are provided as a single unit without the screen console release feature described above.

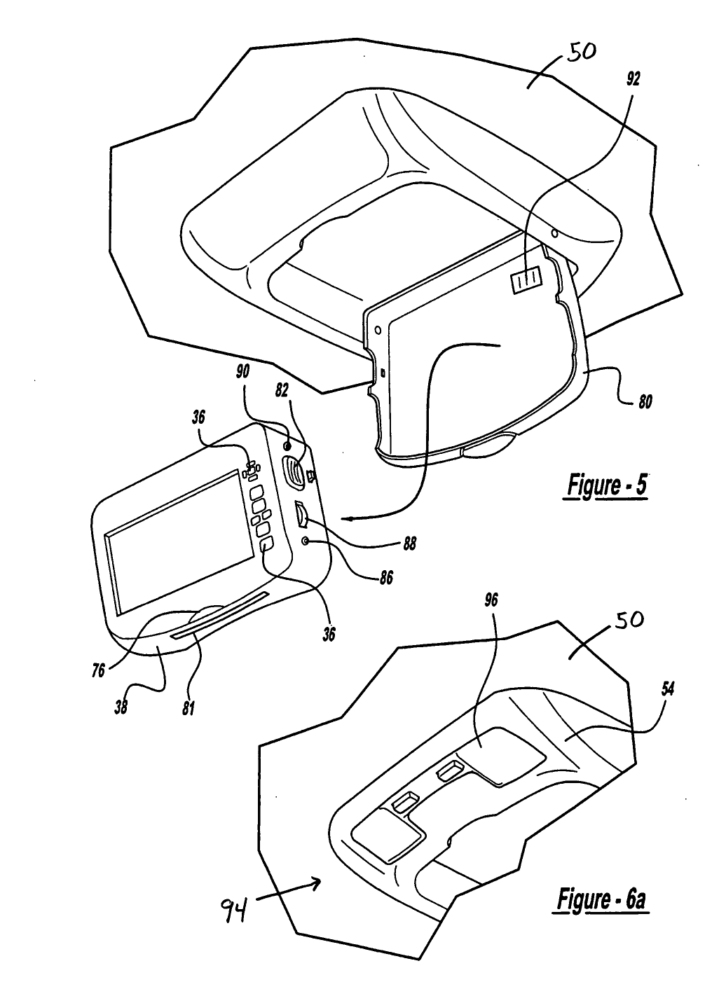

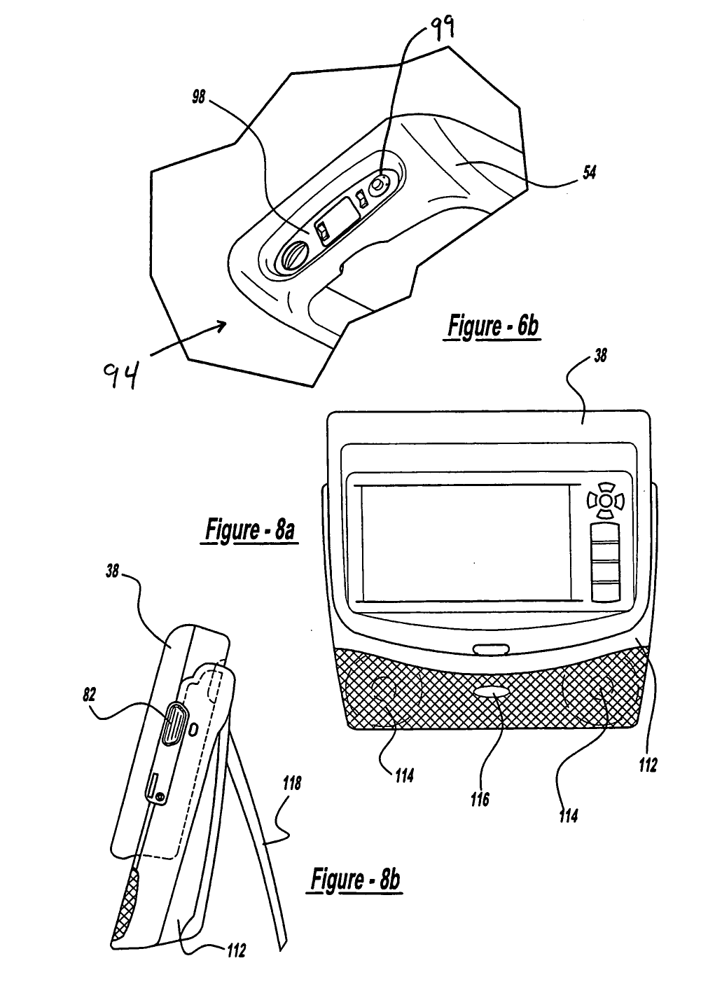

Referring to FIGS. 6a and 6b, a front portion 94 of the bezel portion 54 of the housing 34 may incorporate additional comfort features, including, but not limited to at least one interior lighting system 96 and at least one interior climate control system 98. Additionally, the front portion 94 of the bezel portion 54 may include the integration of a rear seat entertainment module 99 and/or other types of radio station selection control and volume control.

Referring to FIGS. 7a-7c, the second latch mechanism 82 will now be described in further detail. In FIG. 7a, the latch mechanism 82 includes a latch arm 100 rotatably mounted to the screen console 38 and integrally formed with a button portion 102 and an engagement portion 104. The engagement portion 104 is operably associated with a detent 106 positioned in the housing panel 80. When pressure is applied to the button portion 102, the latch arm rotates removing the engagement portion 104 from the detent 106 releasing the second latch mechanism 82 from the panel housing 80. The latch mechanism 82 also includes a retaining slot 108 integrally formed in the screen console 38. The retaining slot 108 is engageable with a corresponding retaining finger 110 integrally formed in the panel housing 80. When the engagement portion 104 of the latch arm 100 has been removed from the detent 106, the retaining slot 108 of the screen console 38 can be disengaged from the retaining finger 110, as shown in FIG. 7b. This facilitates removal of the screen console 38 as shown in FIG. 7c.

One of ordinary skill in the art will appreciate that several variations of this latch mechanism 82 can be used with equal success and, therefore, are within the scope of this disclosure. These include, but are not limited to, positioning the latch arm 100 horizontally with the engagement portion 104 engaging a detent 106 correspondingly positioned in the housing panel 80, and forming the latch mechanism 82 with the latch arm 100, the button portion 102, and engagement portion 104 such that an angle is formed with respect to the positioning of the rotatably mounted latch arm 100 and the engagement portion 104.

Referring to FIGS. 8a and 8b, a stand 112 is shown. The video display system 30 of the present invention can be removed from the housing 34 and operably positioned within the stand 112. The stand 112 may include at least one speaker 114 and a power switch 116. The video display system 30 is releasably retained using the second latch mechanism 82 in the same manner as described above. The stand 112 includes a rear leg 118 rotatably attached to the stand 112, thereby providing support so that the video display system can be substantially vertically positioned for viewing. The stand 112 has a wiring harness connector 92 engageable with a wiring harness connector 93 (shown in FIG. 17) positioned in the screen console 38 as described above providing the required power, audio, etc., connections necessary for operation.

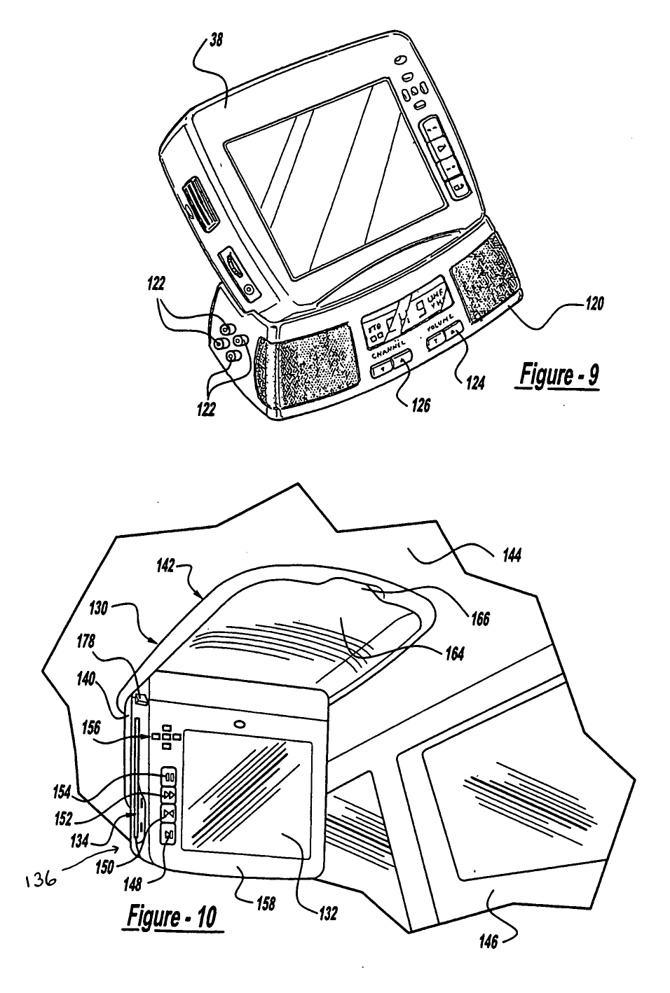

Referring to FIG. 9, the screen console 38 can also be positioned on a tuner 120 and operated either as a DVD player or as a screen for conventionally known TV and cable TV. The tuner also includes connectors for cable, audio, video, and power hookups, shown generally at 122. Additionally, the tuner includes speakers and audio and channel controls shown at 124 and 126.

Referring to FIG. 10, there is shown a video display system 130 in accordance with an alternative embodiment of the present invention. The video display system 130 comprises a screen 132 (e.g., a liquid crystal display (LCD) screen) and a digital video disc (DVD) player 134 integrated in a single housing, referred to hereinafter as the LCD/DVD unit 136. The LCD/DVD unit 136 is removably coupled to a docking member 140, which is in turn pivotably connected to a console 142. The console 142 may be mounted in a number of different areas but in this example is mounted to a headliner 144 of a motor vehicle interior 146. It will be appreciated immediately, however, that the apparatus 130 could just as easily be mounted to a floor console of the vehicle or even on the back of one of the front seats of the vehicle. The apparatus 130 is not limited to automotive applications, and could easily be used within the cabin of a boat or aircraft if desired.

The LCD/DVD unit 136 includes a plurality of controls including a play switch 148, a rewind or search backward switch 150, a fast forward or search forward switch 152 and a pause or still switch 154. A menu control switch assembly 156 enables menu functions to be selected on the display 132.

The compactness of the LCD/DVD unit 136 allows the unit to be readily mounted in a wide variety of areas of a vehicle where a television incorporating a conventional cathode ray tube (CRT) and associated video cassette player would be much to bulky to mount. The entire apparatus 130 is also much lighter in weight, making to easier to secure in overhead areas of a vehicle interior, where a CRT might require significant modifications to the vehicle interior to support the greater weight of a CRT and video cassette player combination.

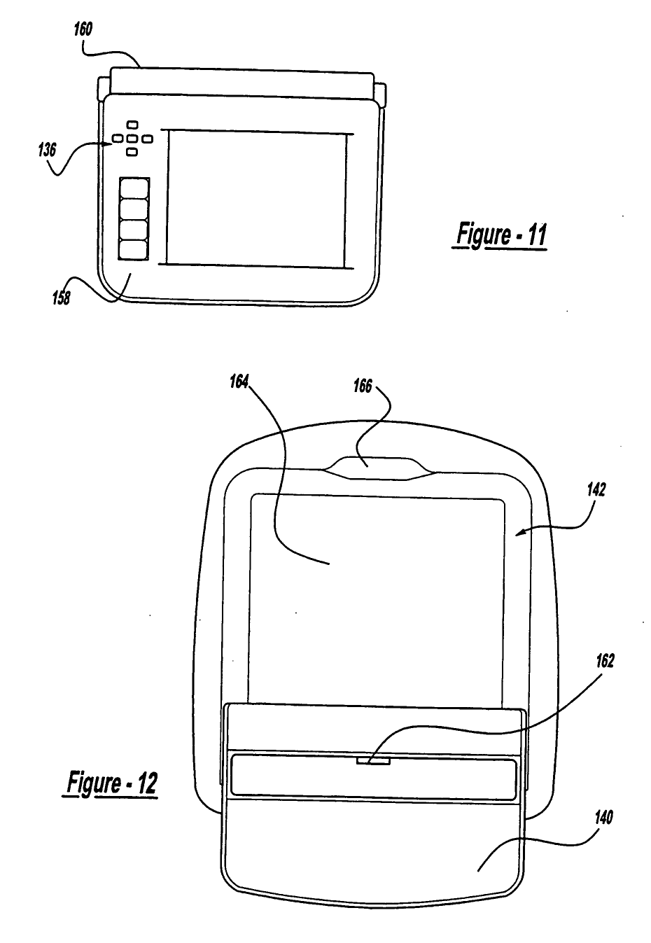

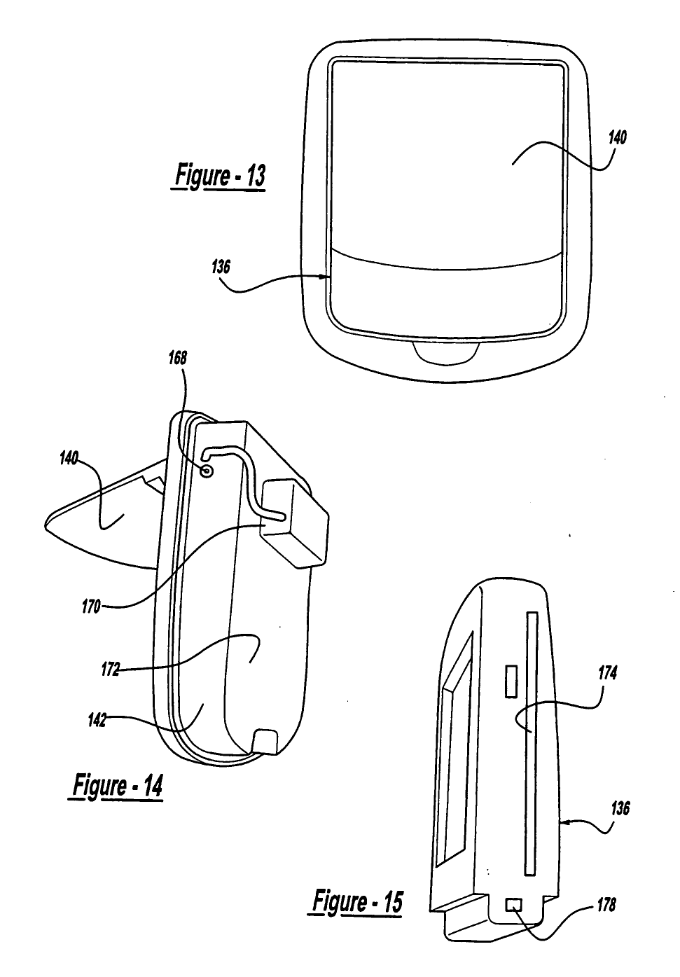

With further reference to FIGS. 10 and 11, the LCD/DVD unit 136 includes a molded plastic housing 158. An upper portion 160 of the housing 158 includes an electrical connector (not shown) for coupling with a mating connector 162, shown in FIG. 12, disposed within the docking member 140. The connectors enable power to be provided to the LCD/DVD unit 136. Connectors suitable for this purpose are of the “drawer” type and are commercially available from a wide variety of manufacturers, such as the AMP Corporation.

With further reference to FIG. 10, the console 142 includes a cavity or recess 164 sufficiently deep to hold the LCD/DVD unit 136 therein. A scalloped portion 166 provides an access point where an individual can insert one or more fingers and pull the LCD/DVD unit 136 down into the position shown in FIG. 10.

Referring to FIGS. 10 and 14, the docking member 140 is pivotably mounted to the console 142 at point 168 (FIG. 14) on opposite sides of the console 142. The LCD/DVD unit 136 can be held in the closed position by any form of spring biased latch which engages within a recess or notch on the docking member 140 to hold the unit 136 up in the recess 164 once the docking member is urged into the closed position. FIG. 14 also illustrates a power supply 170 for providing power to the LCD/DVD unit 136. The power supply 170 is shown attached to a rear surface 172 of the console 142, although it will be appreciated that this could just as easily be enclosed within a portion of the console 142. FIG. 15 illustrates a slot 174 of the DVD player 176 which receives digital video discs for playback in the LCD/DVD unit 136.

With further reference to FIG. 10, a spring loaded latch 178 is positioned on opposite sides of the housing 158 near the upper end 160 thereof. The latches permit the LCD/DVD unit 136 to be quickly detached from the docking member 140 when it is desired to remove the unit 136 from the vehicle. In this manner, the LCD/DVD unit 136 can be used outside the vehicle provided a suitable AC or DC power source is available.

The apparatus 130 of the present invention thus provides a compact means for playing back and viewing digital video discs. The light weight and compact configuration of the apparatus 130 enables it to be mounted at a variety of areas within a vehicle where it would be impossible or impractical to mount a television having a CRT and an associated videocassette player. The apparatus 130 is quickly and easily removable and light enough to be easily carried about and used outside of the vehicle within which its console is mounted. For example, the apparatus 130 may be removed from the vehicle and placed in another docking station which is located externally of the vehicle. In addition, the apparatus 130 may include other features such as a television tuner and/or a cable adapter to enable television programs to be used.

FIG. 18 provides a schematic representation of video screen console or assembly 38. According to an exemplary embodiment, assembly 38 comprises a circuit board 62 (e.g., a printed circuit board) and video screen 40. Circuit board 62 comprises a video display driver 202 configured to direct and/or control operation of screen 40 (e.g., receive the video stream from an applications board and decode it, lighting the appropriate pixels). According to various exemplary embodiments, the circuit board 62 may be connected to an applications board of the display system according to any suitable method. According to an exemplary embodiment, the applications board may control the system's reaction to various inputs and commands. Transmitter/receiver module 76 is attached to a surface 63 of circuit board 62 using leads and is positioned to transmit signals throughout the vehicle or into the vehicle interior and receive signals from within the vehicle. In this embodiment, transmitter/receiver module 76 and video display driver are coupled to the same, single circuit board. Alternatively, either or both of transmitter/receiver module 76 and video display driver 202 may be coupled to a second circuit board coupled to circuit board 62 via a ribbon cable or other electrical connector.

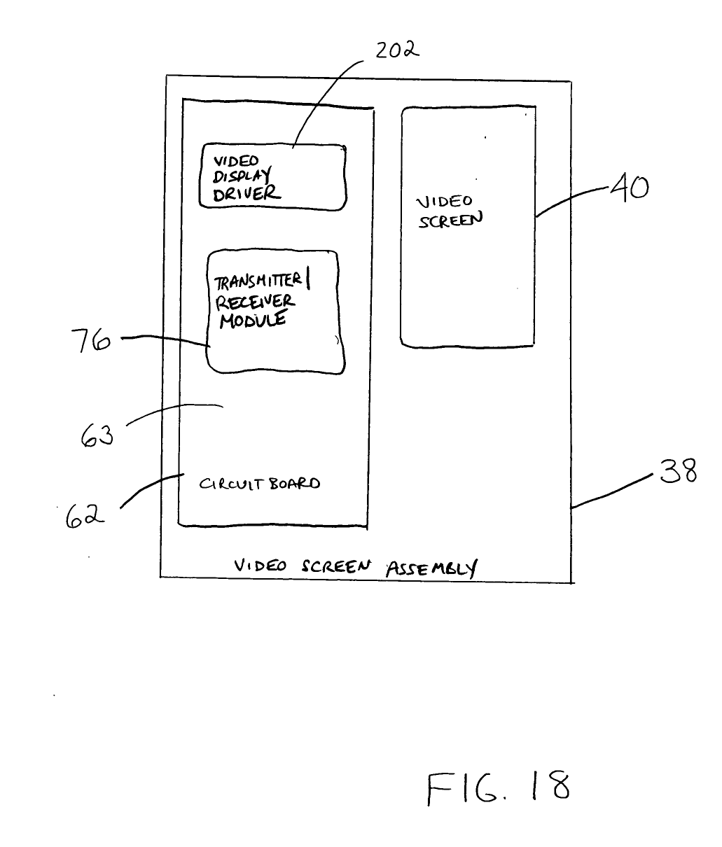

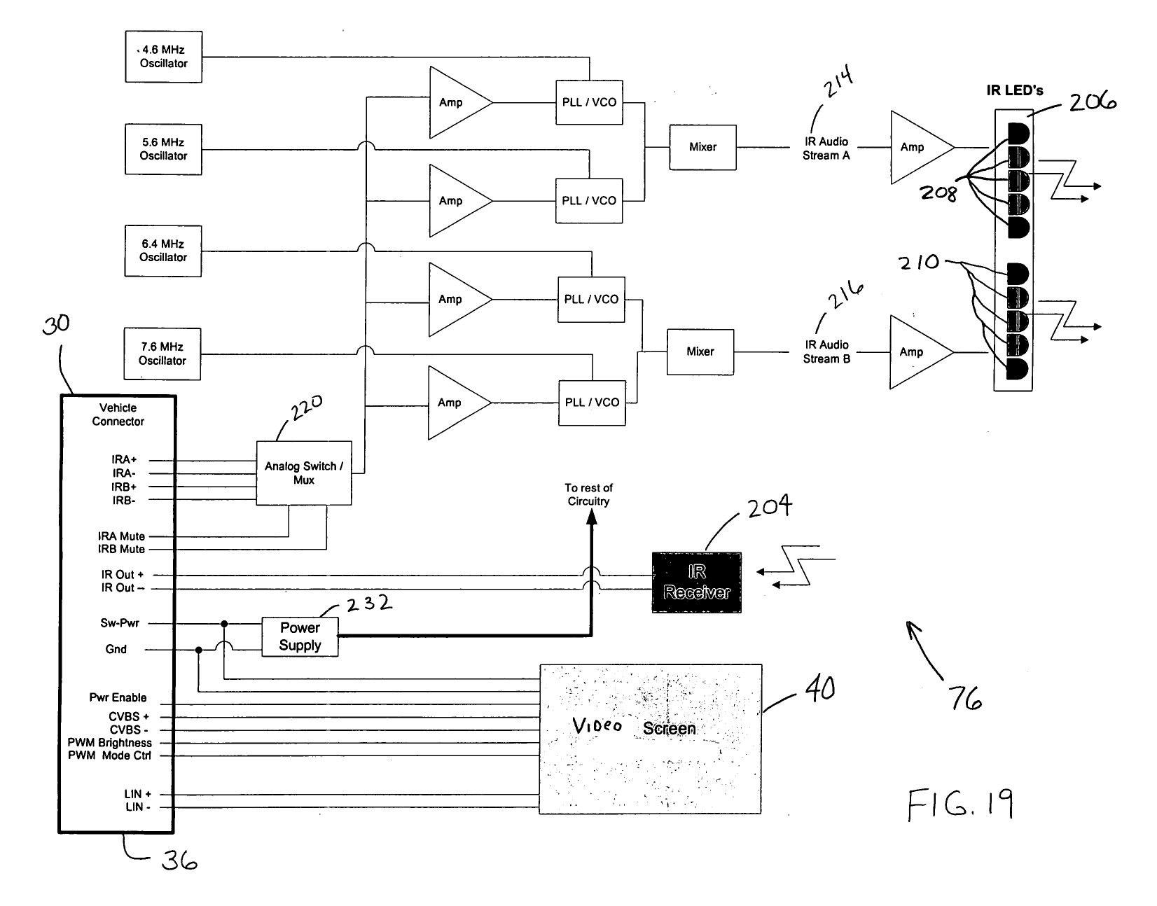

FIG. 19 provides a schematic representation of transmitter/receiver module 76 (e.g., including a transceiver or separate transmit and receive components) according to an exemplary embodiment. Referring to FIG. 19, transmitter/receiver module 76 comprises a power supply 232, an analog switch 220 for controlling infrared audio stream A (214) and infrared audio stream B (216). Module 76 also comprises an infrared transmitter 206 and an infrared receiver 204. Infrared transmitter 206 comprises ten infrared light emitting devices (e.g., light emitting diodes or LEDs) 208, 210. According to various alternative embodiments, the infrared transmitter may comprise any suitable number of light emitting devices (e.g., infrared), and may be a single transceiver component or comprise separate components for transmit and receive functions. Module 76 is connected to display system 30 and the plurality of controls 36 (e.g., audio stream A/B, mute A/B, power, brightness, etc.).

According to an alternative embodiment, the transmitter/receiver module may comprise a Bluetooth® enabled device. For example, the audio devices (e.g., headphones, speakers, etc.) within the vehicle may be Bluetooth® compatible for receiving signals from a Bluetooth® enabled transmitter provided with the video display system. According to various exemplary embodiments, a Bluetooth® enabled transmitter may be provided at any suitable location on and/or within the video display system (e.g., as shown in FIG. 17, on or within housing 34, on screen assembly 38, on circuit board 62, on an application board, etc.).

According to an exemplary embodiment, the Bluetooth® RF (physical layer) operates in the unlicensed ISM band at 2.4 GHz. The system employs a frequency hop transceiver to combat interference and fading and provides multiple FHSS carriers. RF operation uses a shaped, binary frequency modulation to minimize transceiver complexity. The symbol rate is 1 Megasymbol per second (Ms/s) supporting the bit rate of 1 Megabit per second (Mb/s) or, with Enhanced Data Rate, a gross air bit rate of 2 or 3 Mb/s. These modes are known as Basic Rate and Enhanced Data Rate respectively.

According to various exemplary embodiments, the wireless transceiver can be a communication circuit including analog and/or digital components configured to transmit and receive wireless data in any of a variety of data transmission formats, such as a Bluetooth® communications protocol, an IEEE 802.11 communications protocol, or other personal area network protocols or other wireless communications protocols or data formats. The Bluetooth® standard makes use of the free, universal 2.4 GHz Industrial, Scientific, and Medical (ISM) band and a frequency hopping scheme using 1600 hops/second. The Bluetooth® standard further provides the potential for automatic and rapid “ad hoc” wireless connections when two or more devices equipped with RF transceivers operating in accordance with the Bluetooth® standard come into proximity with each other.

FIG. 20 is a partial side view of a video display system 250 according to an exemplary embodiment. Video display system 250 comprises a housing 252 and a screen console or assembly 254. Screen assembly 254 includes a wireless transmitter 256. According to an exemplary embodiment, transmitter 256 comprises a light emitting device such as an infrared transmitter (e.g., one or more LED). Video display system 250 comprises a reflective device or deflector 258 configured to deflect and/or reflect wireless signals transmitted from transmitter 256. According to various exemplary embodiments, the reflective device comprises a mirror-like surface that can be made of any suitable material for reflecting infrared rays. Housing 252 comprises material 260 that is configured to allow transmitted wireless signals to pass through. According to an exemplary embodiment, material 260 may be at least partially translucent and comprise a plurality of light transmissive portions. Reflective device 258 is configured so that transmitter 256 transmits signals throughout the vehicle while screen assembly 254 is in a closed or stowed position.

FIG. 21A is a partial side view of a video display system 270 according to an exemplary embodiment. Video display system 270 comprises a housing 272 and a screen console or assembly 274. Screen assembly 274 includes a first wireless transmitter 276 and a second wireless transmitter 278. According to an exemplary embodiment, transmitters 276 and 278 comprise an infrared transmitter, such one or more LED. FIG. 21B is a detailed partial view of wireless transmitters 276 and 278. As shown in FIG. 21B, transmitters 276 and 278 may be positioned substantially perpendicular to one another to transmit signals in multiple directions. According to various alternative embodiments, the transmitters may be configured according to any suitable configuration.

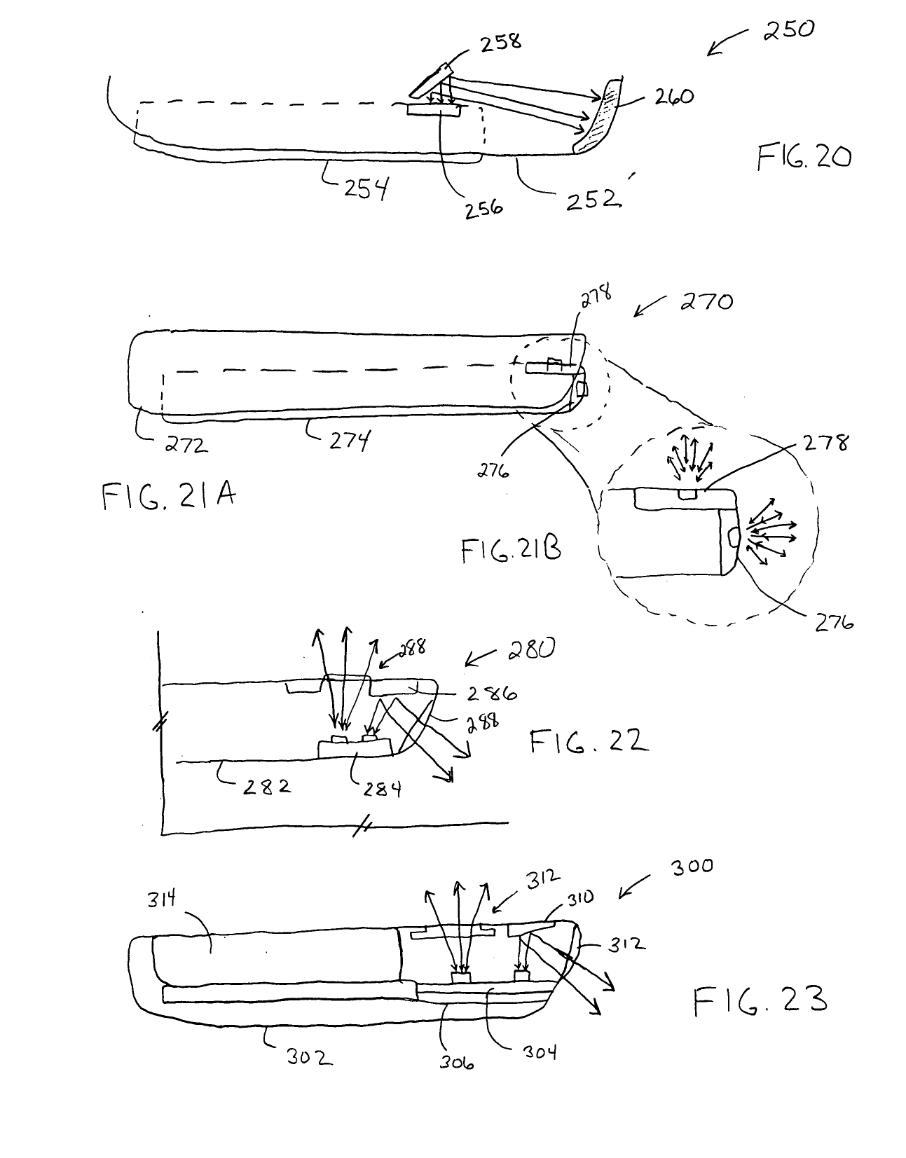

FIG. 22 is a partial side view of a video display system 280 according to an exemplary embodiment. Video display system 280 comprises a screen console or assembly 282 having a wireless transmitter 284. According to an exemplary embodiment, transmitter 284 comprises a light emitting device such as an infrared transmitter (e.g., one or more LED). Screen assembly 282 also includes material 288 that is configured to allow transmitted wireless signals to pass through. According to an exemplary embodiment, material 288 may be at least partially translucent and comprise a plurality of light transmissive portions. Screen assembly 282 further includes reflective device or deflector 286 configured to deflect and/or reflect wireless signals transmitted from transmitter 284. According to various exemplary embodiments, the reflective device comprises a mirror-like surface that can be made of any suitable material for reflecting infrared rays. Reflective device 286 is configured so that transmitter 284 transmits signals throughout the vehicle while screen assembly 282 is in a closed or stowed configuration. As shown in FIG. 22, deflector 286 is positioned within screen assembly 282.

FIG. 23 is a partial side view of a video display system 300 according to an exemplary embodiment. Video display system 300 comprises a screen console or assembly 302 having a wireless transmitter 304. Transmitter 304 is provided on a member 306 positioned proximate video screen 314. According to an exemplary embodiment, transmitter 304 comprises a light emitting device such as an infrared transmitter (e.g., one or more LED). Screen assembly 302 also includes material 312 that is configured to allow transmitted wireless signals to pass through. According to an exemplary embodiment, material 312 may be at least partially translucent and comprise a plurality of light transmissive portions. Screen assembly 302 further includes reflective device or deflector 310 configured to deflect and/or reflect wireless signals transmitted from transmitter 304. According to various exemplary embodiments, the reflective device comprises a mirror-like surface that can be made of any suitable material for reflecting infrared rays. Reflective device 310 is configured so that transmitter 304 transmits signals throughout the vehicle while screen assembly 302 is in a closed or stowed configuration. As shown in FIG. 23, deflector 310 is positioned within screen assembly 302.

According to various exemplary embodiments, any of the above described transmitters may be configured to transmit only, receive only, or transmit and receive wireless signals. In the case of an LED, to receive signals a photodetector, photodiode, phototransistor, photoreceiver IC, demodulator, etc. may be utilized. An LED may be used with a suitable receiver to provide both the transmit and receive functions. According to various alternative embodiments, any suitable transmitter and receiver may be used to transmit and receive wireless signals.

The construction and arrangement of the elements of the system as shown in the exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of fasteners, connectors, etc. may be reversed or otherwise varied, etc. (e.g., the transmitter/receiver module may be provided at various alternative locations such as on a daughter circuit board connected to the video driver board of the screen assembly). It should be noted that the elements and/or assemblies of the system may be constructed from any of a wide variety of materials that provide sufficient strength or durability, including any of a wide variety of moldable plastic materials (such as high-impact plastic or plastic having various coatings, such as hard-coating material) in any of a wide variety of colors, textures and combinations. It should also be noted that the system may be used in association with any of a wide variety of types of components and/or features such as digital displays, electronic displays, etc. Accordingly, all such modifications are intended to be included within the scope of the present system. Other substitutions, modifications, changes and omissions may be made in the design, operating conditions and arrangement of the preferred and other exemplary embodiments without departing from the scope of the present system.

While the above-described embodiments disclose using a liquid crystal display for the screen 40, it is specifically contemplated and, therefore, within the scope of this disclosure that other types of screens could be used with equal results, including, but not limited to, filled emission displays, organic light emitting diode displays, poly light emitting diode displays, plasma displays, etc.

The foregoing discussion discloses and describes a preferred embodiment of the present invention. One skilled in the art will readily recognize from such discussion, and from the accompanying drawings and claims, that various changes, modifications, and variations can be made therein without departure from the true spirit and fair scope of the invention as defined in the following claims.

What is claimed is:

1. A video display system for a vehicle, comprising:
a housing coupled to a vehicle interior element; and
a video screen assembly coupled to the housing and moveable between a stowed position and a non-stowed position;
wherein the assembly comprises a display screen and a wireless transmitter configured to transmit a first wireless signal.

2. The video display system of claim 1, wherein the wireless transmitter comprises an infrared transmitter configured to transmit an audio signal.

3. The video display system of claim 2, wherein the wireless transmitter further comprises an infrared receiver configured to receive a signal from a remote device.

4. The video display system of claim 1, wherein the assembly further comprises a single circuit board having display driver circuitry and the wireless transmitter mounted thereon.

5. The video display system of claim 4, further comprising a video player configured to provide a video signal to the display driver circuitry.

6. The video display system of claim 1, wherein the wireless transmitter comprises a radio frequency transmitter configured to transmit an audio signal.

7. The video display system of claim 6, wherein the radio frequency transmitter comprises a Bluetooth®-enabled transmitter.

8. The video display system of claim 1, wherein the housing is coupled to a ceiling of the vehicle.

9. A video display system for a vehicle, comprising:
a video source for providing a video signal; and
a video screen assembly comprising a circuit board and a video screen, the video screen assembly being configured to display the video signal;
wherein the circuit board comprises a video driver and a transmitter for transmitting a first wireless signal; and
wherein the video screen assembly is configured to be moveable between a stowed position and a non-stowed position.

10. The display system of claim 9, wherein the transmitter comprises an infrared light emitting diode configured to transmit at least one audio signal.

11. The display system of claim 10, wherein the infrared light emitting diode is configured to emit the first wireless signal into a vehicle interior area when the video screen assembly is provided in the stowed position.

12. The display system of claim 11, further comprising a reflective device configured to reflect the first wireless signal from the infrared light emitting diode through a portion of the video screen assembly when the video screen assembly is provided in the stowed position.

13. The display system of claim 12, wherein the reflective device is provided on the video screen assembly.

14. The display system of claim 9, wherein the transmitter comprises a Bluetooth®-enabled device.

15. The display system of claim 9, wherein the circuit board further comprises a wireless signal receiver configured to receive a wireless audio signal.

16. The display system of claim 15, wherein the wireless signal receiver comprises an infrared signal receiver.

17. The display system of claim 9, wherein the video screen assembly is coupled to a ceiling of the vehicle.

18. A video screen module for a vehicle, comprising:
a video screen assembly comprising a circuit board, the video screen assembly being configured to display a video signal;
wherein the circuit board comprises a video driver, a transmitter for transmitting a first wireless signal, and a receiver for receiving a second wireless signal; and
wherein the video screen assembly is configured to be moveable between a stowed position and a non-stowed position.

19. The video screen module of claim 18, wherein the transmitter comprises an infrared light emitting diode configured to transmit at least one audio signal and the receiver comprise an infrared signal receiver configured to receive at least one audio signal.

20. The video screen module of claim 18, wherein the transmitter and receiver are a single transceiver component.
